(19) United States
(12) Patent Application Publication
(10) Pub. No.: US 2014/0243440 A1
(43) Pub. Date: Aug. 28, 2014

(54) METHOD

(71) Applicants: Jas Pal S. Badyal, Wolsingham (GB); Suzanne Morsch, Woodthorpe (GB)

(72) Inventors: Jas Pal S. Badyal, Wolsingham (GB); Suzanne Morsch, Woodthorpe (GB)

(21) Appl. No.: 14/233,030

(22) PCT Filed: Jul. 18, 2012
(86) PCT No.: PCT/GB2012/051707

§ 371 Date: May 12, 2014

(30) Foreign Application Priority Data
Jul. 19, 2011 (GB) 1112404.7

(51) Int. Cl. C08J 9/00

(52) U.S. Cl. CPC C08J 9/0028
USPC 521/64; 264/41; 524/89

(57) ABSTRACT

A method for producing a porous polymer structure involves (i) forming a polymer; (ii) subsequently contacting the polymer with a nonsolvent and inducing the formation of an emulsion in which the nonsolvent is present as the dispersed phase and the polymer as the continuous phase; and (iii) removing at least some of the nonsolvent so as to leave pores within the polymer, wherein the polymer is formed by exciting one or more molecules in an exciting medium, in particular by pulsed plasma deposition. Emulsion formation in step (ii) may be induced by or in the presence of an emulsion stabilising agent. Also provided is a porous polymer structure produced using the method, and a polymer which is impregnated with an emulsion stabilising agent, for use in the emulsion formation step of the method.

### FIELD OF THE INVENTION

This invention relates to methods for producing porous polymer structures, in particular functionalised porous polymer structures, and to structures produced using such methods.

### BACKGROUND TO THE INVENTION

Porous polymer structures, in which a polymer contains a network of at least partially interconnected pores, are already known.

Materials containing such pore systems can be important in a range of applications, including gas storage [1, 2], fuel cells [3], catalysis [4, 5], sensors [6], filtration [7], chromatography [8, 9], tissue engineering [10, 11], micro fluidic devices [12, 13] and biomineralisation [14]. Polymeric scaffolds can be particularly attractive in many of these cases due to their relatively low cost and light weight.

A common approach for making porous polymer structures involves templated polymerisation around the aqueous phase of a water-in-oil emulsion (a so-called “polyHIPE” process). Variants of this methodology include templated polymerisation around alternative porogenic substances such as salt crystals [15], colloids [16] and non-solvents [17], where the final macroporous structures are obtained by drying, etching or leaching for porogen extraction.

There can be drawbacks to all of these methods, including the consumption of significant amounts of organic solvents and other potentially toxic reagents, and also the associated waste disposal issues. Moreover, polyHIPE materials can suffer from poor mechanical properties [18, 19, 20]. This can lead to problems when they are used in applications such as catalysis, fuel cells, microfluidics and tissue engineering, where in fact thin macroporous films supported on a robust substrate might be a more viable alternative.

One approach employed in the past to produce supported polyHIPE films has been the “breath figure method”, whereby the condensation of water droplets onto a spin cast polymer layer serves to template an interconnected pore structure [21]. Documents such as US-2010/0247762, US-2010/0080917, US-2009/0232982, EP-1 783 162 and JP-2010/070700 also describe the use of the breath figure method to induce pore formation in a film cast polymer layer. However, there can be inherent disadvantages in such methods, including the need for precisely controlled humidity and for organic solvents (the evaporation of which drives water condensation). Furthermore, spin cast polymers can suffer from poor adhesion to the underlying substrate.

It is an aim of the present invention to provide alternative methods for producing porous polymer structures, in particular functionalised porous polymer structures, which methods can overcome or at least mitigate the above described problems.

### STATEMENTS OF THE INVENTION

According to a first aspect of the present invention there is provided a method for producing a porous polymer structure, the method involving:
(i) forming a polymer;
(ii) subsequently contacting the polymer with a nonsolvent and inducing the formation of an emulsion in which the nonsolvent is present as the dispersed phase and the polymer as the continuous phase; and
(iii) removing at least some of the nonsolvent so as to leave pores within the polymer,
   wherein the polymer is formed by exciting one or more molecules in an exciting medium.

The polymer may be formed as a polymer layer (which includes a film) on a substrate. The pores may be at least partially interconnected.

Emulsion formation may be induced by or in the presence of an emulsion stabilising agent such as a surfactant. The polymer may be impregnated with such an emulsion stabilising agent; this may for example occur prior to contact with the nonsolvent and/or the emulsion formation step.

Spontaneous microemulsion formation can occur where a mediating (typically surfactant) species lowers the interfacial energy between two immiscible phases to such an extent that the contacting area is spontaneously maximised by emulsion formation [49, 50]. In the case of the present invention, the immiscible phases are the polymer and the nonsolvent, and an emulsion stabilising agent may be used to lower the interfacial energy between them.

During the pore formation step (iii), suitably all or substantially all (for example 90% w/w or more, or 95 or 98 or in cases 99% w/w or more) of the nonsolvent is removed from the polymer.

In an embodiment of the first aspect of the invention, the method for producing a porous polymer structure involves:
(i) forming a polymer layer on a substrate;
(ii) impregnating the polymer layer with an emulsion stabilising agent;
(iii) contacting the impregnated polymer layer with a nonsolvent;
(iv) inducing the formation of an emulsion in which the nonsolvent is present as the dispersed phase and the polymer as the continuous phase; and
(v) removing at least some of the nonsolvent so as to leave pores (which are suitably at least partially interconnected) within the polymer layer,
   wherein the polymer layer is formed on the substrate by exciting one or more molecules in an exciting medium.

It can be seen that the method of the invention decouples the polymerisation step from the pore formation step. As described above, macroporous polymers are ordinarily fabricated using high internal phase emulsion (HIPE) techniques, where the continuous organic phase consists of the monomer templated around the internal aqueous phase prior to polymerisation, and then the aqueous phase is removed to leave behind a micron-scale interconnected porous structure [48]. These emulsions are necessarily stabilised by the addition of surfactants (which serve to lower the interfacial energy between the two phases, and hence prevent separation), but nonetheless their formation involves extensive mixing of the organic and aqueous phases. The present invention is based on a completely different approach, in which surface polymerisation takes place prior to pore formation. In an embodiment of the invention, emulsion formation is allowed to occur spontaneously between the polymer (which may have been impregnated with a suitable emulsion stabilising agent) and the nonsolvent so as to create porous structures.

This decoupling of the polymerisation and pore formation steps can provide significant advantages, given that conventional emulsions used to fabricate polyHIPE materials are highly complex formulations comprising solvents, surfactants, monomer(s), cross-linker, and polymerisation initiators, and that the molecular structure and concentration of each of these components can affect emulsion stability and the resulting pore dimensions and morphology [48, 61]. In polyHIPE processes, porosity can also be influenced by further factors including the material of the container contacting the emulsion during polymerisation, the temperature, and the mixing speed [48]. Overall this means that a delicate balance of process conditions is typically required to reproducibly fabricate open cell macroporous polymers.

In contrast, decoupling the polymerisation and pore forming processes allows the pore architecture to be controlled independently of the polymerisation step, often facilitating improved control over the pore characteristics.

The method of the invention can also have the advantage of minimising the use of potentially expensive reagents and the generation of undesirable waste products, especially since in many embodiments the nonsolvent can be an aqueous phase.

The invented method may be applied to a wide range of polymers, including both homo- and copolymers. Examples include polymers prepared from polymerisable monomers such as styrenes, alkenes, acrylates and alkyl acrylates (eg methacrylates). In an embodiment, the polymer is a vinyl polymer. It may be a halogenated polymer. It may for example be a vinylbenzyl polymer such as a poly(vinylbenzyl chloride).

The polymer may be formed, typically on a substrate surface, by a range of different techniques, including for example plasma polymerisation, initiated chemical vapour deposition (iCVD), photodeposition, ion-assisted deposition, electron beam polymerisation, gamma-ray polymerisation, target sputtering, or graft polymerisation (which may involve a “grafting to”, “grafting through” or “grafting from” method).

Suitably, the polymer is formed using a solventless deposition technique, for example a plasma deposition technique as described below. Where the nonsolvent is an aqueous nonsolvent, this can allow the method of the invention to be carried out in the absence of, or substantially in the absence of (for example in the presence of 10% w/w or less of, or 5 or 2 or 1% w/w or less of) organic solvents.

The polymer is formed by exciting one or more precursor molecules (for example monomers) in an exciting medium. The exciting medium may for instance be generated using a hot filament, ultraviolet radiation, gamma radiation, ion irradiation, an electron beam, laser radiation, infrared radiation, microwave radiation, or any combination thereof. In general terms it may be created using a flux of electromagnetic radiation, and/or a flux of ionised particles and/or radicals. In a specific embodiment, the exciting medium is a plasma.

Thus, for example, the polymer may be formed on a substrate by contacting the substrate with one or more suitable precursor molecules, in an exciting medium such as a plasma, in order to cause polymerisation of the molecule(s) and deposition of the resultant polymer onto the substrate. The polymer may therefore be formed by plasma deposition.

Plasma (or plasmachemical) deposition processes can provide a solventless approach to the preparation of well-defined polymer films; they involve the deposition of a monomer (or other polymer precursor) onto a substrate within a plasma, which causes the precursor molecules to polymerise as they are deposited. Plasma-activated polymer deposition processes have been widely documented in the past—see for example Grill, A, “Cold Plasma in Materials Fabrication: From Fundamentals to Applications”, IEEE Press: Piscataway, N.J., USA, 1994; Yasuda, H, “Plasma Polymerization”, Academic Press: New York, 1985; and Badyal, J P S, Chemistry in Britain 37 (2001): 45-46.

A plasma deposition process may be carried out in the gas phase, typically under sub-atmospheric conditions, or on a liquid precursor or precursor-carrying vehicle as described in WO-03/101621.

In an embodiment, the polymer is formed using a pulsed excitation and deposition process, ie using a pulsed exciting medium, in particular a pulsed plasma. In an embodiment, it is formed using an atomised liquid spray plasma deposition process, in which, again, the plasma may be pulsed.

Pulsed plasmachemical deposition typically entails modulating an electrical discharge on the microsecond-millisecond timescale in the presence of one or more suitable precursor molecules, thereby triggering precursor activation and reactive site generation at the substrate surface (via VUV irradiation, and/or ion and/or electron bombardment) during each short (typically microsecond) duty cycle on-period. This is followed by conventional polymerisation of the precursor(s) during each relatively long (typically millisecond) off-period. Polymerisation can thus proceed in the absence of, or at least with reduced, UV-, ion-, or electron-induced damage [23, 24].

Pulsed plasma deposition can result in polymeric layers which retain a high proportion of the original functional moieties, and thus in structurally well-defined coatings [25, 26].

The advantages of using (pulsed) plasma deposition, in order to form the polymer, can include the potential applicability of the technique to a wide range of substrate materials and geometries, with the resulting deposited layer conforming well to the underlying surface. The technique can provide a straightforward and effective method for functionalising solid surfaces, being a single step, solventless and substrate-independent process. The inherent reactive nature of the electrical discharge can ensure good adhesion to the substrate via free radical sites created at the interface during ignition of the exciting medium. Moreover during pulsed plasma deposition, the level of surface functionality can be tailored by adjusting the plasma duty cycle.

A polymer which has been applied to a substrate using plasma deposition will typically exhibit good adhesion to the substrate surface. The applied polymer will typically form as a uniform conformal coating over the entire area of the substrate which is exposed to the relevant precursor(s) during the deposition process, regardless of substrate geometry or surface morphology. Such a polymer will also typically exhibit a high level of structural retention of the relevant precursor(s), particularly when the polymer has been deposited at relatively high flow rates and/or low average powers such as can be achieved using pulsed plasma deposition or atomised liquid spray plasma deposition.

Previous examples of pulsed plasma deposited well-defined functional films include poly(glycidyl methacrylate) [27, 28], poly(bromoethyl-acrylate) [29], poly(vinyl aniline) [30], poly(vinylbenzyl chloride) [31], poly(allylmercaptan) [32], poly(N-acryloylsarcosine methyl ester) [33], poly(4-vinyl pyridine) [34] and poly(hydroxyethyl methacrylate) [35].

Although plasmachemical functionalisation of pre-assembled porous supports is known [36], the only attempts to induce porosity directly into plasma deposited films have entailed selective leaching of low molecular weight material [37], which can suffer from a lack of control over length scales and blistering or dissolution [38]. In accordance with the present invention, a polymer layer can be templated to yield a porous layer containing an open cell structure, simply by inducing emulsion formation after the polymer deposition step, with a suitable nonsolvent.

Any suitable conditions may be employed for the polymer formation step (i) of the invented method, depending on the nature of the polymer and where applicable of the coating needed on the substrate surface. The step is suitably carried out in the vapour phase. By way of example, and in particular when the polymer is formed using a pulsed exciting medium and/or when the polymer is a vinyl polymer (more particularly a vinylbenzyl polymer), one or more of the following conditions may be used:
a. a pressure of from 0.01 mbar to 1 bar, for example from 0.01 or 0.1 mbar to 1 mbar or from 0.1 to 0.5 mbar, such as about 0.2 mbar.
b. a temperature of from 0 to 300° C., for example from 10 or 15 to 70° C. or from 15 to 30° C., such as room temperature (which may be from about 18 to 25° C., such as about 20° C.).
c. a power (or in the case of a pulsed exciting medium, a peak power) of from 1 to 500 W, for example from 5 to 70 W or from 5 or 10 to 60 or 50 W, such as about 30 W.
d. in the case of a pulsed exciting medium (for example a pulsed plasma), a duty cycle on-period of from 1 μs to 5 ms, for example from 1 to 500 μs or from 1 to 200 μs or from 50 to 200 μs, such as about 100 μs.
e. in the case of a pulsed exciting medium (for example a pulsed plasma), a duty cycle off-period of from 1 μs to 500 ms, for example from 1 to 250 ms or from 1 to 100 ms or from 1 to 10 ms, such as about 4 ms.
f. in the case of a pulsed exciting medium (for example a pulsed plasma), a ratio of duty cycle on-period to off-period of from 1×10⁻⁵ to 1.0, or from 0.001 to 0.1, for example from 0.001 to 0.05 or from 0.01 to 0.05 or from 0.01 to 0.04, such as about 0.025.

In the case of a pulsed exciting medium such as a pulsed plasma, conditions (d) to (f) may be particularly preferred, more particularly conditions (d) and (f). Yet more particularly, it may be preferred to use a duty cycle on-period of from 1 to 50 or from 1 to 10 μs, and/or a ratio of duty cycle on-period to off-period of from 1×10⁻⁵ to 1×10⁻⁴.

The polymer may be formed as a coating, on a substrate, with any appropriate thickness. The coating may for example have a thickness of 1 nm or greater, or of 10 or 50 nm or greater, or of 75 or 100 nm or greater. Suitably it has a thickness of 150 nm or greater, or in cases of 0.2 or 0.5 or 1 or 10 μm or greater. This thickness may be up to 100 μm, or up to 10 or 1 μm, or up to 500 or 200 nm. It may for example be from 1 nm to 100 μm, or from 50 to 500 nm, or from 50 to 200 nm, or from 75 to 200 nm or from 100 to 200 nm.

The pores formed in the polymer may for example have an internal diameter of 1 nm or greater, or of 0.1 μm or greater, or of 0.5 μm or greater, or of 1 μm or greater. They may for example have an internal diameter of up to 50 μm, or of up to 20 μm, or of up to 10 μm, such as from 0.5 to 50 μm or from 1 to 10 μm. The pore wall thickness may for example be 1 nm or greater, or 10 or 50 or 100 nm or greater; it may be up to 1 μm, or up to 500 nm, such as from 50 to 500 nm or from 100 to 300 nm.

An emulsion stabilising agent, if used, should be an agent capable of stabilising a nonsolvent-in-polymer (typically water-in-oil) emulsion within the polymer, in which the dispersed phase is the nonsolvent and the continuous phase is the polymer itself. It should thus act to lower the interfacial energy between the nonsolvent and the polymer. The emulsion stabilising agent may be chosen to affect emulsion properties such as the size and proximity of dispersed phase elements (eg micelles), and in turn to influence properties of the pores formed from the emulsion.

In general, an emulsion stabilising agent should be an entity having (a) a “nonsolvent-philic” component which has a greater affinity for the nonsolvent than for the polymer and (b) a “polymer-philic” or “nonsolvent-phobic” component which has a greater affinity for the polymer than for the nonsolvent. In an embodiment, component (a) is a hydrophilic component, for example an ionic and/or polar substituent. In an embodiment, component (b) is a hydrophobic component. If for example the polymer includes one or more aromatic components such as phenyl moieties, component (b) may include one or more aromatic components for example containing phenyl rings.

In particular where the polymer includes one or more aromatic components, the emulsion stabilising agent may be an aromatic dye, as these compounds are often readily able to disperse within an aromatic polymer matrix via π-π interactions [51, 52].

The emulsion stabilising agent is thus suitably miscible with the polymer, which can also facilitate its migration through the polymer matrix.

In an embodiment, the emulsion stabilising agent is an amphiphilic species, such as a surfactant (for example an anionic, cationic, nonionic, amphoteric or zwitterionic surfactant). In an embodiment it may be an anionic surfactant, for example an alkyl sulphate such as sodium dodecyl sulphate. In an embodiment it may be an aromatic dye such as cresyl violet perchlorate. In an embodiment it is selected from cresyl violet perchlorate, sodium dodecyl sulphate and mixtures thereof. In a specific embodiment it is cresyl violet perchlorate.

In an embodiment, the emulsion stabilising agent incorporates a marker component, for example a coloured and/or fluorescent component. This can facilitate subsequent analysis of the porous polymer structure, as a small amount of the stabilising agent is likely to remain within the structure after pore formation, and can be used to help detect pore location and/or geometry.

The polymer may be impregnated with an emulsion stabilising agent for example by immersing the polymer in a solution or suspension of the emulsion stabilising agent. In an embodiment, the solution or suspension is an aqueous solution or suspension, in particular an aqueous solution.

In an embodiment, the polymer itself may function as an emulsion stabiliser: in this case, there may be no need for a separate emulsion stabilising agent. The polymer may therefore incorporate one or more moieties of the type described above, for example anionic moieties. In particular, the polymer may be amphiphilic, ie it may incorporate both nonsolvent-philic and nonsolvent-phobic moieties, which moieties may be present on the polymer backbone and/or its side chains. More particularly, the polymer may incorporate both hydrophilic and hydrophobic moieties.

In an embodiment, the polymer has a nonsolvent-phobic (in particular hydrophobic) backbone carrying one or more nonsolvent-philic (in particular hydrophilic) functional groups. An essentially hydrophobic polymer such as a vinyl polymer, in particular a vinylbenzyl polymer, may for example be derivatised by the incorporation of one or more hydrophilic functional groups. Alternatively, the polymer may have a nonsolvent-philic backbone carrying one or more nonsolvent-phobic functional groups. It may be a copolymer comprising both nonsolvent-philic and nonsolvent-phobic monomer units.

In an embodiment, the hydrophilic functional groups carried on the polymer are cyclodextrin molecules, which may be linked to an appropriate polymer backbone for example through ether linkages between hydroxyl groups on the cyclodextrin molecules and functional groups on the polymer. Cyclodextrin molecules can form inclusion complexes, in which another substance is held as a “guest” within the cavity of a cyclodextrin “host” molecule; a polymer which incorporates cyclodextrin moieties may therefore be used as a release system for an active substance such as a drug or fragrance, which may be loaded into and subsequently released from the cyclodextrin cavities. In accordance with the present invention, such a cyclodextrin-derivatised polymer may be formed into a porous polymer by contacting it with an aqueous nonsolvent, the polymer itself (due to the presence of the hydrophilic cyclodextrin moieties on the hydrophobic polymer backbone) acting as an amphiphilic emulsion stabilising agent. The resulting porous polymer will thus incorporate cyclodextrin molecules, which are capable of receiving and subsequently releasing substances such as drugs and fragrances, at the internal pore surfaces as well as at the external polymer surface.

In general, in the method of the invention the polymer formed in step (i) may incorporate one or more functional groups, which can thus result in a porous polymer structure which has surface functionality both inside the pores and at the external polymer surface. Such functional groups may be present on the polymer prior to pore formation, and/or may be introduced by a suitable polymer-derivatisation reaction once the pores have been formed, and/or may be introduced during the process of contacting the polymer with the nonsolvent.

The nonsolvent used in the invented method must be a nonsolvent for the polymer. In other words, it should be immiscible with the polymer to at least some extent, under the operating conditions used, such that to at least some extent, the nonsolvent and the polymer exist together in two distinct phases. The nonsolvent may however be a solvent for the emulsion stabilising agent, if used. The nonsolvent, or at least a quantity thereof, may therefore be present in the form of a solution or suspension of an emulsion stabilising agent in the nonsolvent, with which the polymer may be contacted and/or impregnated prior to or during emulsion formation.

In an embodiment, the nonsolvent is an aqueous liquid (which includes water), and the emulsion generated in the polymer may be a water-in-oil emulsion. In an embodiment, the nonsolvent is water.

In preferred embodiments of the invention, the polymer can be contacted with the nonsolvent without the need to control the humidity of the environment in which the contact takes place, and/or without the need to form droplets of the nonsolvent (which itself typically requires precise control over operating conditions such as temperature, pressure, humidity and nonsolvent flow rate). This can provide advantages over the prior art “breath figure methods” discussed above. By way of example, contact between the nonsolvent and the polymer may be achieved simply by immersing the polymer in the nonsolvent, and/or by carrying out a reaction on the polymer in the presence of the nonsolvent.

In the method of the invention, “inducing” emulsion formation can mean subjecting the polymer to conditions under which the required type of emulsion forms within it. This may mean contacting the polymer with one or more additional agents and/or subjecting it to particular conditions, for example of temperature and/or pressure. Suitably these agents and/or conditions are such that the emulsion forms spontaneously between the polymer and the nonsolvent.

In an embodiment, emulsion formation is induced at an elevated temperature, which can help to increase the mobility of the polymer and hence increase its ability to deform at the polymer/nonsolvent interface, in turn improving the stability of the resultant emulsion. In this context an elevated temperature might for instance be 30° C. or higher, or 40 or 50° C. or higher. The temperature during this step might suitably be up to 300° C., or up to 250 or 200 or 150 or 100° C., or in cases up to 90 or 80 or 70° C. It might for example be about 60° C. The temperature at which emulsion formation is induced may depend on the natures of the polymer, the nonsolvent and if applicable the emulsion stabilising agent.

Subsequent removal of the nonsolvent may be by any suitable process. For example the polymer may be dried for a period of time to allow the nonsolvent to evaporate from within the pores. The drying may be carried out at an elevated temperature and/or a reduced pressure, and/or may be aided by movement such as by rotation.

Functional groups within the polymer can also provide scope for secondary functionalisation of the eventual porous structure. For example, surface grafted-poly(vinylbenzyl chloride) films can be utilised for surface initiated atom transfer radical polymerisation (ATRP) of poly(glycidyl methacrylate) to yield epoxide group functionalised porous layers, as shown in the examples below.

Thus, in an embodiment of the invention, the method also involves functionalising the polymer (typically chemically) after pore formation. Polymer functionalisation can involve attaching a functional moiety to, or forming a functional moiety on, the polymer molecules. Attachment of a functional moiety may be done by any suitable method, for example by a plasmachemical process or by a more conventional wet technique such as ATRP.

The present invention can allow the incorporation of a wide variety of functionalities within the porous structure, including both within the pores and at the external surfaces of the structure. Such functionalities could for instance be selected from hydrophilicity, hydrophobicity, oil repellency, bioactivity, detectability (eg through labeled moieties such as dyes or fluorescent tags), increased or reduced reactivity, increased or reduced adhesion, specific binding affinity, antifouling properties, antimicrobial activity, the addition of guest-host complexes or other forms of encapsulating entities (for instance for use in drug delivery), and combinations thereof. The porous structure may be functionalised in a manner which makes it suitable for use as a substrate for other materials and/or processes, for example as a substrate for tissue engineering or cell culture.

Polymer functionalisation may also be used to actuate the pores in the structure, and/or to influence their size. For example, the polymer may include, or may subsequently be attached to, a moiety which swells (preferably reversibly) in the presence of certain materials and/or under certain conditions. When swollen, this moiety would serve to block, or at least to reduce the size of, the pores in the structure. When the swelling was reversed, the pore size would be increased again, thus effectively “actuating” the pores in readiness for a desired application.

Thus, in an embodiment the polymer may be functionalised with a moiety which is capable of influencing the size and/or shape of the pores depending on its physical state, for instance in response to its solvent environment, pH, temperature and/or pressure, and/or in response to an applied electric field, magnetic field and/or light. In an embodiment, such a moiety is capable of influencing the size and/or shape of the pores in response to its solvent environment.

By way of example, the moiety may be hydrophilic, capable of swelling on exposure to an aqueous solvent. Such a moiety may also be capable of reverting to its unswollen form by exposure to a hygroscopic solvent. Poly(glycidyl)methacrylate “brushes” grafted onto polymers such as poly(vinylbenzyl chloride) have been shown to exhibit such behavior.

According to a second aspect of the invention, there is provided a porous polymer structure produced using a method according to the first aspect. The structure may have any desired size and shape. It may comprise a substrate on which the polymer has been deposited, or otherwise formed, prior to pore formation.

Porous polymer structures produced according to the invention can have potential application in—amongst others—catalysis, fuel cells, gas storage, biotechnology, drug delivery, tissue engineering, filtration, lubrication, adhesion, fluid transport and control, and microfluidic devices. Thus, a third aspect of the invention provides a product which is formed from or incorporates a porous polymer structure according to the second aspect. Such products include for example fuel cells, microfluidic devices, filters and fluid (in particular gas) barriers.

A fourth aspect of the invention provides a polymer which is impregnated with an emulsion stabilising agent, for use in the emulsion formation step of a method according to the first aspect. The polymer may be carried on a substrate. The emulsion stabilising agent may be an amphiphilic species.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, for example for the concentration of a component or a temperature, then a range of values defined by a combination of any of the upper limits with any of the lower limits may also be implied.

In this specification, references to properties such as solubilities, liquid phases and the like are—unless stated otherwise—to properties measured under ambient conditions, ie at atmospheric pressure and at a temperature of from 18 to 25° C., for example about 20° C.

The present invention will now be further described with reference to the following non-limiting examples and the accompanying figures, of which:

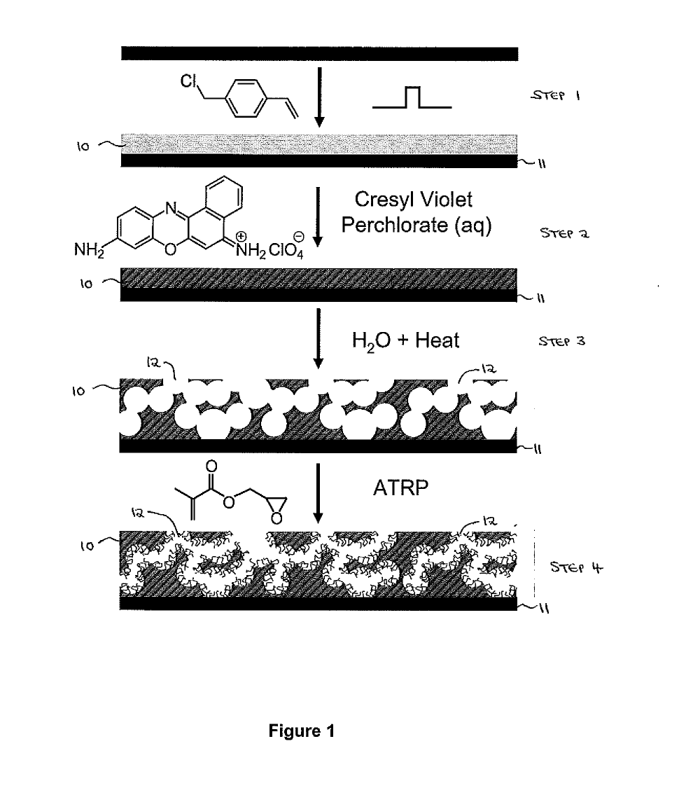

FIG. 1 shows schematically a method in accordance with the invention;

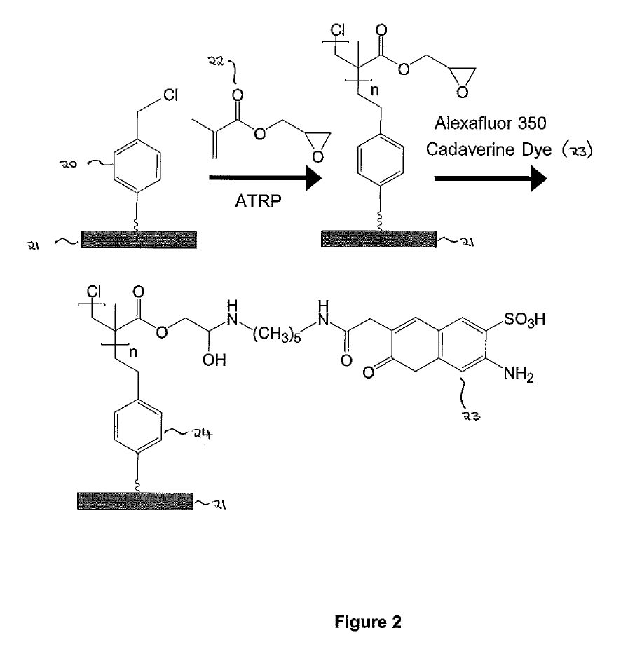

FIG. 2 shows schematically a polymer-functionalising step carried, out in accordance with the invention, in Example 1 below;

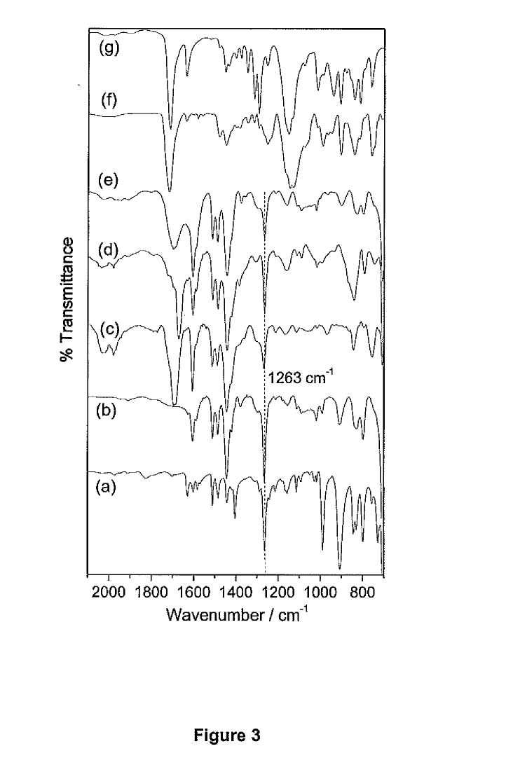

FIG. 3 shows infrared spectra for materials used and produced in Example 1;

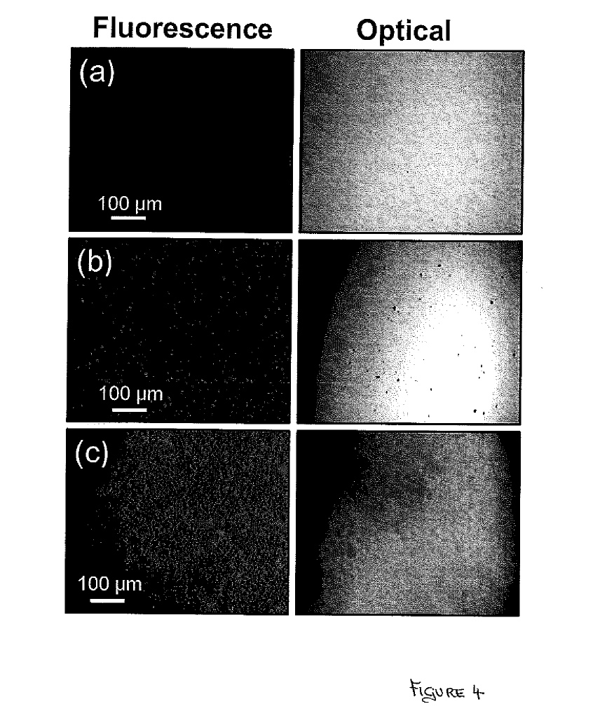

FIG. 4 shows fluorescence and optical micrographs of polymer films produced in Example 1;

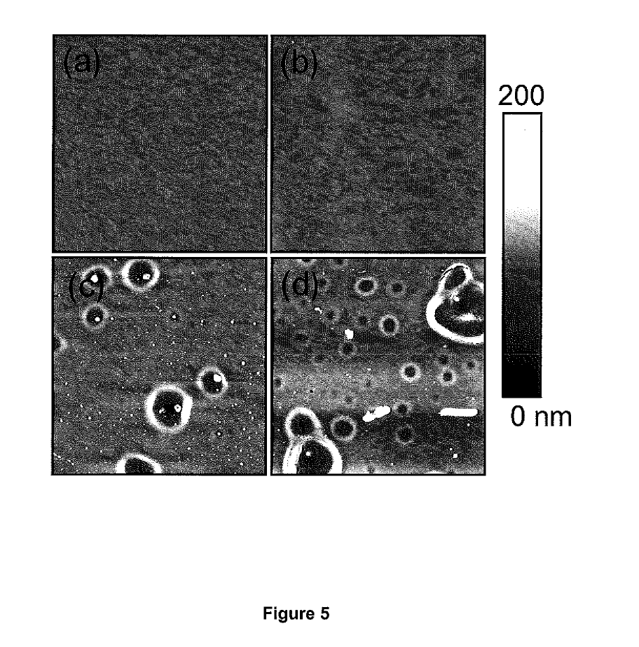

FIG. 5 shows AFM (atomic force microscopy) micrographs of polymer films produced in Example 1;

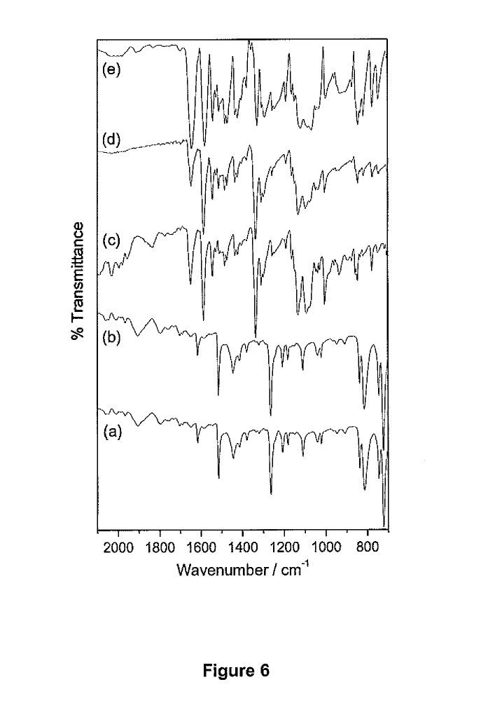

FIG. 6 shows further infrared spectra for materials used and produced in Example 1;

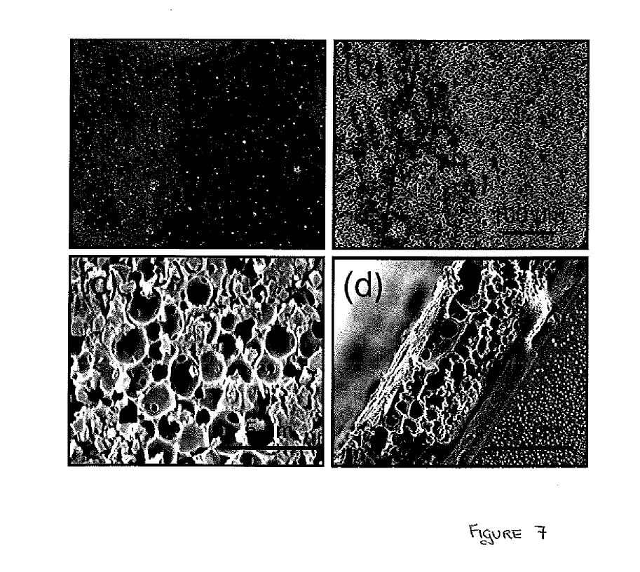

FIG. 7 shows SEM (scanning electron microscope) images of polymer films produced in Example 1;

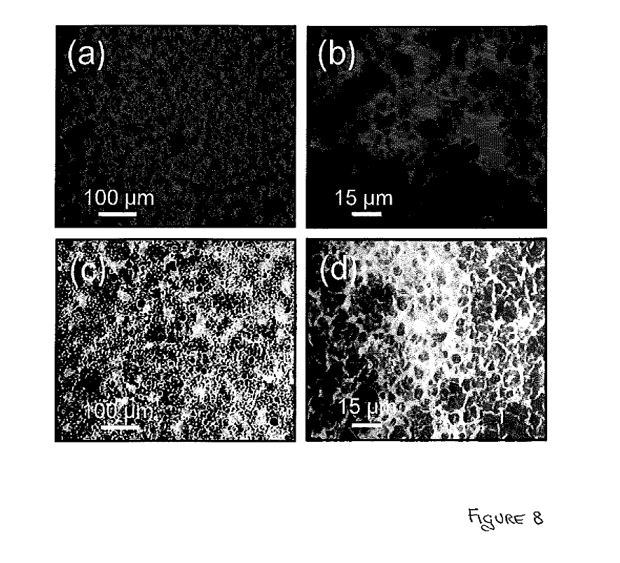

FIG. 8 shows fluorescence micrographs of polymer films produced in Example 1;

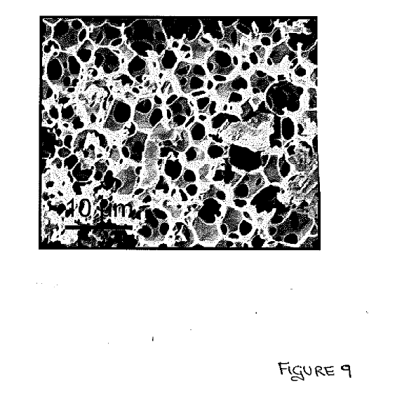

FIG. 9 is an SEM image of a porous polymer film produced according to the invention in Example 2; and

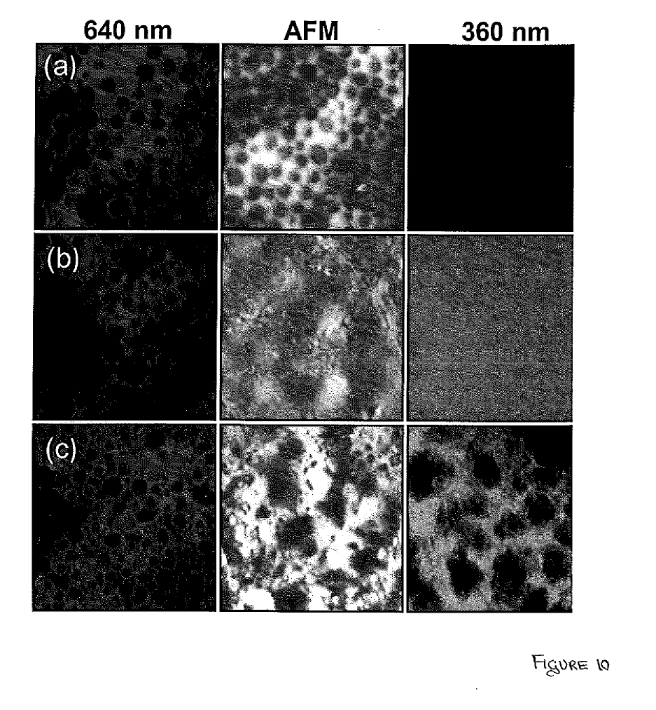

FIG. 10 shows AFM micrographs and fluorescence micrographs of polymer films produced in Examples 1 and 3.

### DETAILED DESCRIPTION

The FIG. 1 scheme The scheme shown in FIG. 1 illustrates a method in accordance with the invention, in which:
Step 1—a poly(vinylbenzyl chloride) film 10 is deposited onto a substrate 11 using a pulsed plasma deposition process;
Step 2—the polymer film is impregnated with an amphiphilic surfactant (in this case cresyl violet perchlorate) by immersing the coated substrate 11 in an aqueous solution of the surfactant;
Step 3—the impregnated polymer layer is rinsed in water at an elevated temperature, followed by drying, in order to generate a network of interconnected pores 12 throughout the polymer; and
Step 4—the pores are surface functionalised using, in this case, an ATRP process and an epoxide reagent.

### Example 1

In this example, a porous poly(vinylbenzyl chloride) structure was prepared in accordance with the invention.

1 Pulsed Plasma Deposition of Poly(Vinylbenzyl Chloride)

Plasma depositions were performed inside a cylindrical glass reactor (5.5 cm diameter, 475 cm³ volume) located within a Faraday cage. The system was evacuated using a 30 L min⁻¹ mechanical rotary pump via a liquid nitrogen cold trap (base pressure less than 3×10⁻³ mbar and leak rate better than 6×10⁻⁹ molecules per second [39]). A copper coil wound around the reactor (4 mm diameter, 10 turns, located 10 cm away from the gas inlet) was connected to a 13.56 MHz radio frequency (RF) power supply via an L-C matching network. The RF power supply was triggered using a signal generator.

All apparatus was thoroughly scrubbed with detergent and hot water, rinsed with propan-2-ol, and oven dried. Substrate preparation comprised successive sonication of glass microscope slides (VWR International LLC) or silicon wafers (MEMC Electronic Materials Inc) in propan-2-ol and cyclohexane for 15 minutes each prior to insertion into the centre of the plasma reactor. Further cleaning entailed running a 50 W continuous wave air plasma at 0.2 mbar for 30 minutes.

Vinylbenzyl chloride precursor (+97%, Aldrich) was loaded into a sealable glass tube, degassed via several freeze-pump-thaw cycles, and attached to the plasma deposition chamber. Monomer vapour was then allowed to purge through the apparatus at a pressure of 0.2 mbar for 3 minutes prior to electrical discharge ignition. Optimum pulsed plasma deposition duty cycle parameters were 100 μs on-period and 4 ms off-period in conjuction with 30 W peak power [31]. Following plasma extinction, precursor vapour was allowed to continue to pass through the system for a further 3 minutes, followed by evacuation to base pressure.

2 Porous Film Formation

Substrates bearing 3 μm thick pulsed plasma deposited poly(vinylbenzyl chloride) layers were immersed into a 0.15 mg L⁻¹ aqueous solution of cresyl violet perchlorate (analytical grade, Aldrich) for 16 hours. Following removal from solution, the samples were thoroughly rinsed with high purity water (BS 3978 Grade 1), and soaked in fresh high purity water for an additional 16 hours at room temperature. In order to induce pore formation, the samples were then placed inside a sealed jar containing high purity water and stored at 60° C. for 1 hour. Finally, the films were dried under ambient conditions for 16 hours prior to analysis.

3 Surface-Initiated ATRP of Poly(Glycidyl Methacrylate)

FIG. 2 shows schematically a further polymer-functionalising step which was carried out on the macroporous polymer structure as follows. The process used for the functionalising step was ATRP (atom transfer radical polymerisation).

Porous poly(vinylbenzyl chloride)-functionalised substrates were placed inside a sealable glass tube containing 5 mmol copper (I) bromide (+98%, Aldrich), 1 mmol copper (II) bromide (+99%, Aldrich), 12 mmol 2,2′-bipyridyl (+99.9%, Aldrich), 0.05 mol glycidyl methacrylate (+97%, Aldrich), and 4 mL propan-2-ol (reagent grade, Fisher).

The mixture was thoroughly degassed using freeze-pump-thaw cycles and then allowed to undergo polymerisation at room temperature for 4 hours. Cleaning and removal of any physisorbed ATRP polymer was accomplished by successive rinsing with propan-2-ol and tetrahydrofuran.

Fluorescent tagging of the surface grafted poly(glycidyl methacrylate) epoxide centres was achieved by brief submersion into a 1 mg dm⁻³ aqueous solution of Alexafluor 350 Cadaverine dye (analytical grade, Invitrogen Ltd), followed by extensive rinsing with high purity water.

Thus, as seen in FIG. 2, the polymer layer 20 on the substrate 21 is firstly grafted with the glycidyl methacrylate 22, following which nucleophilic ring opening of the epoxide centres by the dye 23 results in a labelled polymer layer 24.

4. Characterisation

Film thicknesses following pulsed plasma deposition were measured using a spectrophotometer (nkd-6000, Aquila Instruments Ltd). Transmittance-reflectance curves (350-1000 nm wavelength range) were acquired for each sample and fitted to a Cauchy material model using a modified Levenberg-Marquardt algorithm [40].

Surface elemental compositions were obtained by X-ray photoelectron spectroscopy (XPS) using a VG ESCALAB II electron spectrometer equipped with a non-monochromated Mg Kα X-ray source (1253.6 eV) and a concentric hemispherical analyser. Photoemitted electrons were collected at a take-off angle of 20° from the substrate normal, with electron detection in the constant analyser energy mode (CAE, pass energy=20 eV). Experimentally determined instrument sensitivity factors were taken as C (1s): N (1s): O (1s): Cl (2p) equals 1.00:0.63:0.39:0.35.

Infrared spectra were acquired using a FTIR spectrometer (Perkin-Elmer Spectrum One) operating with a liquid nitrogen cooled MCT detector set at 4 cm⁻¹ resolution across the 700-4000 cm⁻¹ range. The instrument was fitted with a variable angle reflection-absorption accessory (Specac) set to an angle of 66° for silicon wafer substrates and adjusted for p-polarisation.

Fluorescence microscopy was performed using an Olympus IX-70 system (DeltaVision RT, Applied Precision Inc, WA). Images were collected using excitation wavelengths of 640 nm and 360 nm corresponding to the absorption maxima of cresyl violet perchlorate and the Alexafluor 350 Cadaverine dye respectively.

Surface micrographs were obtained with a scanning electron microscope (Cambridge Stereoscan 240). Prepared specimens were placed onto carbon discs and then mounted onto aluminium holders, followed by deposition of 15 nm gold coating (Polaron SEM coating unit). For cross-sectional images, samples were frozen and snapped under liquid nitrogen prior to mounting.

AFM images were acquired in tapping mode at 20° C. in ambient air (Digital Instruments Nanoscope III, Santa Barbara, Calif.). The tapping mode tip had a spring constant of 42-83 Nm⁻¹ (Nanoprobe Inc). Sessile drop contact angle measurements were made at 20° C. using a video capture apparatus (VCA 2500 XE, AST Products Inc) and 2 μL high purity water droplets (BS 3978 Grade 1).

5 Results

5.1 Pulsed Plasma Deposition of Poly(Vinylbenzyl Chloride)

XPS analysis of pulsed plasma deposited poly(vinylbenzyl chloride) yielded elemental compositions corresponding to the expected theoretical values based on the vinylbenzyl chloride precursor, thereby indicating good structural retention of the benzyl chloride functionality [31]—see Table 1 below. In addition, the absence of a Si(2p) XPS signal confirmed pinhole-free coverage of the underlying silicon wafer substrate.

TABLE 1

| Pulsed plasma deposited | | Elemental composition | | | |
|---|---|---|---|---|---|
| poly(vinylbenzyl chloride) | | C % | O % | N % | Cl % |
| As deposited | Theoretical | 90 | 0 | 0 | 10 |
| | Experimental | 90 ± 1 | 0 | 0 | 10 ± 1 |
| Immersion in cresyl | Experimental | 73 ± 2 | 20 ± 2 | 4 ± 1 | 3 ± 1 |
| violet (aq) | | | | | |
| Cresyl violet (aq) + | Experimental | 79 ± 2 | 14 ± 2 | 2 ± 1 | 5 ± 1 |
| 16 hr water rinsing | | | | | |
| at 22° C. | | | | | |

Further evidence for the structural integrity of the pulsed plasma deposited poly(vinylbenzyl chloride) films was obtained by infrared spectroscopy, where the main fingerprint features matched those associated with the monomer. The infrared spectra are shown in FIG. 3, in which trace (a) is the vinylbenzyl chloride monomer; (b) is the pulsed plasma deposited poly(vinylbenzyl chloride); (c) is the pulsed plasma deposited poly(vinylbenzyl chloride) following immersion in cresyl violet perchlorate solution; (d) is the dye-impregnated polymer following 16 hours' water rinsing at 22° C. and 16 hours' drying in air at 22° C.; (e) is the product (d) following its immersion in water at 60° C. for 1 hour and then drying for 16 hours in air at 22° C.; (f) is the poly(glycidyl methacrylate) ATRP grafted onto the product (e); and (g) is the glycidyl methacrylate monomer.

Both trace (b) for the plasma deposited polymer and trace (a) for the monomer include the halide functionality at 1263 cm⁻¹ (CH₂ wag mode for CH₂—Cl) and parasubstituted benzene ring stretches at 1495 cm⁻¹ and 1603 cm^{-1 [}41]. In addition, the disappearance of the vinyl double bond stretch at 1629 cm⁻¹ is consistent with polymerisation.

A linear film deposition rate of 191±17 nm min⁻¹ and water contact angle values of 80±1° (not hydrophilic) were measured. Optical micrographs and fluorescence images (gathered at the excitation wavelength for cresyl violet perchlorate) were both featureless, thereby confirming that the deposited films were smooth and homogenous.

FIG. 4 shows the fluorescence and corresponding optical micrographs (×10 magnification) of the poly(vinylbenzyl chloride) film (a) as deposited; (b) following immersion in cresyl violet perchlorate solution; and (c) following immersion in cresyl violet perchlorate solution, rinsing in water at 22° C. for 16 hours, soaking in water at 60° C. for 60 minutes, and then drying in air at 22° C. for 16 hours.

5.2 Interaction with the Cresyl Violet Perchlorate Amphiphile

Fluorescence microscopy showed that immersion of the pulsed plasma deposited poly(vinylbenzyl chloride) films in cresyl violet perchlorate solution for 16 hours resulted in uptake of the fluorophore, as seen in FIG. 4. Subsurface penetration of the cresyl violet perchlorate was evident by the greater number of crystals detected by fluorescence microscopy compared to those visible at the surface by optical microscopy (again, see FIG. 4).

Furthermore, XPS elemental analysis confirmed the presence of cresyl violet perchlorate on the surface of the pulsed plasma deposited layers via detection of N (1s) and O (1s) fluorophore signals, as seen in Table 1. Infrared spectroscopy identified a broad absorbance centred at 1690 cm⁻¹ (H—O—H bend attributed to the crystallisation of water associated with cresyl violet perchlorate) [41, 42], as seen in FIG. 3. This was found to be absent when N,N-dimethyl formamide was employed instead of water as the solvent for cresyl violet perchlorate under otherwise identical conditions (N,N-dimethyl formamide is an alternative polar solvent which dissolves cresyl violet perchlorate [43]). Retention of the benzyl chloride infrared absorbances confirmed that no chemical changes to the polymer bulk had taken place during contact with the cresyl violet perchlorate solution (FIG. 3).

In addition to the aforementioned macroscale examination by fluorescence and optical microscopy, AFM was employed to monitor the microscale structure. The resultant 20 μm×20 μm AFM micrographs are shown in FIG. 5. Tapping mode height images confirmed that the pulsed plasma deposited poly(vinylbenzyl chloride) surfaces were featureless (a), and only a slight roughening was visible following 16 hours' immersion in high purity water and then drying in air at 22° C. for 16 hours (b). In contrast, immersion in aqueous cresyl violet perchlorate solution for 16 hours and then drying in air at 22° C. for 16 hours gave rise to crater formation around crystals on the film surface (c). Subsequent rinsing of these samples in high purity water at room temperature for 16 hours, followed by drying in air at 22° C. for 16 hours, removed the crystals to yield additional crater features (d).

Partial removal of cresyl violet perchlorate from the surface during rinsing is supported by XPS analysis, which indicated a corresponding drop in surface oxygen and nitrogen content associated with the fluorophore, as seen in Table 1.

Interactions between cresyl violet perchlorate and the pulsed plasma deposited poly(vinylbenzyl chloride) films were further investigated using 4-methylbenzyl chloride as an analogue to represent the pendant benzyl chloride functionality contained in the polymer layers. Infrared spectra taken for 1 g dm⁻³ solutions of cresyl violet perchlorate in 4-methylbenzyl chloride showed no perturbation in the position or intensity of the fingerprint region infrared absorbances for 4-methylbenzyl chloride, thereby providing further confirmation that no chemical reaction is to be expected to occur between the pulsed plasma deposited poly(vinylbenzyl chloride) layers and cresyl violet perchlorate.

The infrared spectra for this part of the experiment are shown in FIG. 6, in which trace (a) is 4-methylbenzyl chloride; (b) is the 0.1 mg dm⁻³ solution of cresyl violet perchlorate in 4-methylbenzyl chloride; (c) is the solvent-subtracted spectrum of cresyl violet perchlorate dissolved in 4-methylbenzyl chloride; (d) is the solvent-subtracted spectrum of cresyl violet perchlorate dissolved in water; and (e) is the cresyl violet perchlorate bulk crystalline material. Table 2 below summarises the full-width-at-half-maximum (FWHM) peak widths corresponding to FIG. 6.

TABLE 2

| | Peak FWHM (cm⁻¹) | | |
|---|---|---|---|
| | 4-Methylbenzyl | Water | Bulk |
| Absorbance [64] | chloride solution | solution | crystal |
| 1642 cm⁻¹ (in plane fused ring | 20 | 23 | 36 |
| vibration) | | | |
| 1579 cm⁻¹ (NH bending of amino | 15 | 18 | 26 |
| groups) | | | |
| 1543 cm⁻¹ (NH₂ out-of-plane bend) | 10 | 11 | 17 |

Subtraction of the 4-methylbenzyl chloride infrared spectrum from that of the solution yielded the characteristic absorbances of cresyl violet perchlorate. These absorbances were comparable in width to those measured for cresyl violet perchlorate dissolved in water, and notably sharper than those observed for the bulk crystalline material. This is indicative of free rotation in both liquids, ie cresyl violet perchlorate can be solvated by both water and 4-methylbenzyl chloride (and therefore by polyvinylbenzyl chloride).

5.3 Macroporous (polyHIPE) Structure Formation

In order to create macropores, the samples which had been immersed in aqueous cresyl violet perchlorate solution, and rinsed in water, were stored in high purity water for 1 hour at 60° C. During this period, the polymer layer appearance changed from translucent (prior to heating) to opaque, and remained so upon subsequent drying in air. Fluorescence and optical micrographs revealed an interconnected polyHIPE structure with pore diameters of 1-10 μm (which is comparable to the 3D pore geometry of conventional polyHIPE structures), as seen in FIG. 4.

These macropores were also clearly visible by high resolution SEM: see FIG. 7. The four SEM images in FIG. 7 are of the pulsed plasma deposited poly(vinylbenzyl chloride) following 16 hour immersion in aqueous cresyl violet perchlorate solution and then: (a) subsequent immersion in water at 22° C. for 1 hour and drying in air at 22° C. for 16 hours; and (b)-(d) subsequent immersion in water at 60° C. for 1 hour and drying in air at 22° C. for 16 hours, where (d) corresponds to the cross-section. The pore diameters ranged from 1 to 10 μm. The interconnecting pore hole size range was 201±65 nm in diameter. The pore wall thickness range was 172±80 nm.

The smooth and largely spherical pore morphology is consistent with solvent templating [44, 45, 46]. Cross-sectional SEM micrographs confirm that porosity extends throughout the polymer films, which are distended from an initial thickness of 3 μm to 10 μm. These measurements effectively eliminate partial dissolution of plasmachemical polymer layers as being an alternative explanation for the creation of pores [37].

5.4 Surface Functionalisation of Macropores

Pulsed plasma deposited poly(vinylbenzyl chloride) layers have previously been used for the initiation of ATRP to create polymer brushes [31, 33]. The infrared spectra of the fabricated porous poly(vinylbenzyl chloride) films indicated retention of the ATRP initiating benzyl chloride functionality (FIG. 3). After ATRP grafting of glycidyl methacrylate onto the macroporous films, infrared spectroscopy showed characteristic signature absorbances of poly(glycidyl methacrylate) [27, 41] at 1726 cm⁻¹ (C═O ester stretch, instead of 1714 cm⁻¹ for the monomer due to conjugation with the vinyl group), 1152 cm⁻¹ (C—O stretch), 1254 cm⁻¹ (epoxide ring breathing), 906 cm⁻¹ (antisymmetric epoxide ring deformation), and 841 cm⁻¹ (symmetrical epoxide ring deformation): again, see FIG. 3. Absence of the glycidyl methacrylate monomer vinyl absorbances at 1637 cm⁻¹ (C═C stretch) and 941 cm⁻¹ (vinyl CH₂ wag) provided additional evidence for ATRP having taken place.

Subsequent fluorescent tagging of the poly(glycidyl methacrylate) brushes via nucleophilic ring opening of the epoxide centres was carried out using a dilute solution of Alexafluor 350 Cadaverine dye (FIG. 2). Fluorescence microscopy confirmed reaction of the fluorophore with the poly(glycidyl methacrylate) brushes, as seen in FIG. 8. Imaging at the excitation wavelengths of 640 nm and 360 nm for both cresyl violet perchlorate and Alexafluor 350 Cadaverine dye respectively confirmed the grafting of poly(glycidyl methacrylate) brushes directly onto the underlying porous structure.

In FIG. 8, fluorescence micrographs (a) and (b) show the pulsed plasma deposited poly(vinylbenzyl chloride) film following immersion in aqueous cresyl violet perchlorate solution for 16 hours and rinsing in water at 60° C. for 1 hour (red excitation at 640 nm for cresyl violet perchlorate); whilst (c) and (d) show the resultant macroporous film following its exposure to ATRP grafting conditions for glycidyl methacrylate for 4 hours and then immersion in Alexafluor 350 Cadaverine dye (excitation wavelengths for cresyl violet perchlorate (640 nm—red) and Alexaflour 350 Cadaverine dye (360 nm-blue)).

### Example 2

### Control Experiments

A series of control experiments, using alternative reagents, was undertaken to further elucidate the mechanism of pore formation. These experiments employed identical conditions to those used in Example 1 to generate macroporous structures in pulsed plasma deposited poly(vinylbenzyl chloride) films (ie 16 hour immersion in cresyl violet perchlorate solution, 16 hour rinsing in nonsolvent (water) at 22° C., immersion in nonsolvent at 60° C. for 1 hour, and air drying).

First of all, rinsing the polymer films with only deionised water (in the absence of cresyl violet perchlorate) produced no porosity (featureless AFM, fluorescence and optical micrographs), thereby confirming that the surfactant plays, in this case, a critical role in pore formation. Replacement of water with N,N-dimethyl formamide (an alternative polar solvent) throughout also resulted in the absence of porosity, which demonstrates the importance of the nonsolvent (in this case water) for templating.

Finally, the choice of sodium dodecyl sulphate as a different amphiphile for mediating the interaction between water and polymer (16 hour immersion in 0.5% (w/v) aqueous sodium dodecyl sulphate solution at 22° C., followed by rinsing in water, heating at 60° C. in water for one hour, and drying in air at 22° C. for 16 hours) caused the appearance of the polymer film to change from translucent to opaque during heating. SEM images taken after drying (see FIG. 9) revealed the formation of macroporous (polyHIPE) structures, thereby confirming that amphiphilic surfactant action between water and pulsed plasma deposited poly(vinylbenzyl chloride) can underpin the formation of the macroporous structures.

### Example 3

### Pore Size Actuation

ATRP grafted poly(glycidyl methacrylate) brushes tagged with Alexafluor 350 Cadaverine dye have previously been shown to exhibit solvent responsive behaviour [47]. Owing to the hydrophilic nature of the fluorophore, these tagged brushes swell upon exposure to water, which in turn can be removed by exposure to hygroscopic organic solvents.

AFM topography measurements of the ATRP grafted macroporous polymer film produced in Example 1 showed complete coverage of pore features, thereby indicating that the swollen tagged poly(glycidyl methacrylate) brushes had filled the pores. In this example, the thickness (length) of the ATRP-grafted poly(glycidyl methacrylate) brushes had been optimised so as to be comparable in dimension to the host pore sizes when extended (swollen).

Furthermore, the underlying porous poly(vinylbenzyl chloride) structure could be observed using fluorescence microscopy taken at the excitation wavelength for cresyl violet perchlorate (640 nm-red), whilst images taken using the excitation wavelength of Alexafluor 350 Cadaverine dye (360 nm-blue) over the same area showed very little contrast, indicating the presence of the tagged polymer brushes across the entire pore structure.

The 50 μm×50 μm tapping mode AFM images (z scale is 1500 nm) and corresponding fluorescence micrographs are shown in FIG. 10. The images show the pulsed plasma deposited poly(vinylbenzyl chloride) (a) following immersion in aqueous cresyl violet perchlorate solution and then rinsing at 60° C. for 1 hour; (b) following exposure of (a) to ATRP grafting conditions for glycidyl methacrylate for 12 hours, brief immersion in Alexafluor 350 Cadaverine dye and then 16 hours' aqueous rinsing at 22° C.; and (c) following immersion of (b) in tetrahydrofuran and drying.

As verified by the fluorescence micrographs and the AFM height images in FIG. 10, water removal (accomplished by soaking the polymer layer in the hygroscopic solvent tetrahydrofuran) resulted in the restoration of porosity. This behaviour was found to be reversible, and can therefore be used as the basis for pore actuation.

### DISCUSSION OF THE EXAMPLES

In the present case, the favourable interaction of cresyl violet perchlorate with both water and poly(vinylbenzyl chloride) can be understood by consideration of its molecular structure, as seen in FIG. 1. The ionic component of the dye molecule confers hydrophilicity, whilst the extended aromatic structure facilitates interaction with the benzyl chloride moieties contained within the poly(vinylbenzyl chloride). Control experiments using 4-methylbenzyl chloride have confirmed this behaviour, as seen in FIG. 6. Indeed, many similar organic dyes have previously been shown to disperse within aromatic polymer matrices via π-π interactions [51, 52].

The utilisation of an alternative amphiphilic species (sodium dodecyl sulphate, which is known to mediate interactions between vinylbenzyl chloride and water [53, 54]) has also been shown to impart porosity in a poly(vinylbenzyl chloride) matrix. In contrast, the use of an organic solvent (for example N,N-dimethyl formamide) instead of water is less likely to lead to emulsion formation with aromatic polymers due to its higher miscibility with them [55]. Indeed, poly(vinylbenzyl chloride) has been reported to dissolve in N,N-dimethyl formamide [56], which helps to account for why the pulsed plasma deposited poly(vinylbenzyl chloride) layers used in these experiments were not templated by N,N-dimethyl formamide solutions.

In keeping with conventional bulk emulsion polymerisation methods, a finite amount of the surfactant is likely to be retained within the porous polymer structure [57]. This is due to the equilibrium dispersion of surfactant between the organic and aqueous phases. UV-Vis measurements showed that cresyl violet perchlorate partially disperses from aqueous solutions into 4-methyl benzyl chloride liquid, and vice versa following a 16 hour equilibration period. In the present study, the retention of a very small amount of the cresyl violet perchlorate fluorophore within the porous polymer films has allowed fluorescence microscopy to be used as an analytical tool, which offers the advantage of film inspection under ambient conditions (in contrast to SEM) as well as the potential for examination of subsurface morphology.

Apart from the mediating effect of surfactants, the stability of conventional water-in-oil microemulsions can also be enhanced by increasing the viscosity of the organic phase [58]. In the case of a pulsed plasma deposited poly(vinylbenzyl chloride), although the polymer is not sufficiently flexible at room temperature to form emulsions, the plasmachemical layer can be considered to become a highly viscous organic phase at elevated temperatures. AFM height images show shallow crater formation at the film surface following exposure to cresyl violet perchlorate solution under ambient conditions, which is indicative of a limited amount of film deformation occurring at the solid-liquid interface around water droplets in order to maximise interfacial contact, as seen in FIG. 5. However, this effect is enhanced at raised temperatures, with the greater polymer chain mobility allowing the molecules to stretch around water droplets to create an emulsion. This is akin to the thermoplastic behaviour of conventional poly(vinylbenzyl chloride), which becomes more flexible at elevated temperatures [59, 60].

The presently proposed mechanism for pore generation can therefore be influenced by a combination of surfactant (stabilising agent) action and polymer flexibility. A key feature of the invention is that unlike many traditional approaches where polymerisation takes place post emulsion (pore) formation, the present method effectively decouples the polymerisation step completely from emulsion formation, which can give the processing advantages referred to above. This is important given that conventional emulsions used to fabricate polyHIPE materials are highly complex formulations comprising solvents, surfactants, monomer(s), cross-linker, and polymerisation initiators, where the molecular structure and concentration of each of these components affects emulsion stability and the resulting pore dimensions and morphology [48, 61]. In such cases, porosity is also influenced by further factors including the material of the container contacting the emulsion during polymerisation, temperature, and mixing speed [48]. Overall this means that a delicate balance of process conditions is required to reproducibly fabricate conventional open cell macroporous polymers.

By decoupling the polymerisation and pore formation steps, the present method can allow better control over the macromolecular architecture for a variety of surfactants (including cresyl violet perchlorate, which is not ordinarily considered to behave as a surfactant due to its small size). Raising the temperature can be expected to affect the flexibility of the polymer layer during the pore formation step, which will lead to increased coalescence of water phase droplets to yield larger pore sizes (analogous to decreasing the viscosity of the organic phase of a standard HIPE mixture [59, 60, 65]).

Other variables for controlling pore size include pressure [66] and surfactant concentration [67]. Furthermore, given that the flexibility of a plasma-deposited polymer layer can be controlled by varying the plasma deposition parameters, this can also provide a means for tailoring pore geometries.

The invented method can, moreover, allow the pore architecture and the surface functionality to be controlled independently of one another.

The practical advantages of the technique described in this example include that the plasmachemical deposition step is substrate-independent and solventless, whilst the spontaneous emulsion formation requires only the use of environmentally friendly aqueous solutions. A straightforward extension of this approach can be envisaged for the fabrication of a whole host of functionalised porous structures, given the wide range of plasmachemical deposited functional layers that are available.

In addition, the porous structures generated by this method can be further functionalised by either plasmachemical or conventional wet techniques (eg ATRP), which can broaden the scope for potential applications (given the wide array of monomers and functionalities available-including bioactive hydrophilic polymers [62, 63]).

### REFERENCES

(1) Furukawa, H.; Yaghi, O. M. J. Am. Chem. Soc. 2009, 131, 8875.
(2) Wang, H.; Gao, Q.; Hu, J. J. Am. Chem. Soc. 2009, 131, 7016.
(3) Ding, Y.; Chen, M.; Erlebacher, J. J. Am. Chem. Soc. 2004, 126, 6876.
(4) Yu, J-S.; Kang, S.; Yoon, S. K.; Chai, G. J. Am. Chem. Soc. 2002, 124, 9382.
(5) Pierre, S. J.; Thies, J. C.; Dureault, A.; Cameron, N. R.; van Hest, J. C. M.; Carette, N.; Michon, T.; Weberskirch, R. Adv. Mater. 2006, 18, 1822.
(6) Zhao, C.; Danish, E.; Cameron, N. R.; Kataky, R. J. Mater. Chem. 2007, 17, 2446.
(7) Ito, Y.; Ochiai, Y.; Park, Y. S.; Imanishi, Y. J. Am. Chem. Soc. 1997, 119, 1619.
(8) Mellors, J. S.; Jorgenson, J. W. Anal. Chem. 2004, 76, 5441.
(9) Bedair, M.; El Rassi, Z. J. Chromatogr. A 2005, 1079, 236.
(10) Barbetta, A.; Massimi, M.; Devirgiliis, L. C.; Dentini, M. Biomacromolecules 2006, 7, 3059.
(11) Bokhari, M.; Carnachan, R. J.; Przyborski S. A.; Cameron, N. R. J. Mater. Chem. 2007, 17, 4088.
(12) Kjeang, E.; Michel, R.; Harrington, D. A.; Djilali, N.; Sinton, D. J. Am. Chem. Soc. 2008, 130, 4000.
(13) Simms, H. M.; Brotherton, C. M.; Good, B. T.; Davis, R. H.; Anseth, K. S.; Bowman, C. N. Lab Chip 2005, 5, 151.
(14) Li, X.; Coffer, J. L.; Chen, Y.; Pinizzotto, R. F.; Newey, J.; Canham, L. T. J. Am. Chem. Soc. 1998, 120, 11706.
(15) Burdick, J. A.; Frankel, D.; Derrell, W. S.; Anseth, K. S. Biomaterials 2003, 24, 1613
(16) Jiang, P.; McFarland, M. J. J. Am. Chem. Soc. 2004, 126, 13778.
(17) Xu, H.; Ling, X. Y.; van Bennekom, J.; Duan, X.; Ludden, M. J. W.; Reinhoudt, D. N.; Wessling, M.; Lammertink, R. G. H.; Huskens, J. J. Am. Chem. Soc. 2009, 131, 797.
(18) Normatov J.; Silverstein, M. S. Macromolecules 2007, 40, 8329.
(19) Menner, A.; Powell, R.; Bismarck, A. Soft Matter 2006, 2, 337.
(20) Youssef, C.; Backov, R. Treguer, M.; Birot, M.; Deleuze, H. J. Polym. Sci. A 2010, 48, 2942.
(21) Heiko, U.; Bunz, F. Adv. Mater. 2006, 18, 973.
(22) Gates, S. M.; Dubois, G.; Ryan, E. T.; Grill, A.; Lui, M.; Gidley, D. J. Electrochem. Soc. 2009, 159, G156.
(23) Ryan, M. E.; Hynes, A. M.; Badyal, J. P. S. Chem. Mater. 1996, 8, 37.
(24) Badyal, J. P. S. Chem. Br. 2001, 37, 45.
(25) Teare, D. O. H.; Schofield, W. C. E.; Garrod, R. P.; Badyal, J. P. S. Langmuir 2005, 21, 10818.
(26) Savage, C. R.; Timmons, R. B. Chem. Mater. 1991, 3, 575.
(27) Tarducci, C.; Kinmond, E.; Brewer, S.; Willis, C.; Badyal, J. P. S. Chem. Mater. 2000, 12, 1884.
(28) Harris, L. G.; Schofield, W. C. E.; Badyal, J. P. S. Chem. Mater. 2007, 19, 1546.
(29) Garrod, R. P.; Harris, L. G.; Schofield, W. C. E.; McGettrick, J.; Ward, L. J.; Teare, D. O. H.; Badyal, J. P. S. Langmuir 2007, 23, 689.
(30) Harris, L. G.; Schofield, W. C. E.; Doores, K. J.; Davis, B. G.; Badyal, J. P. S. J. Am. Chem. Soc. 2009, 131, 7755.
(31) Teare, D. O. H.; Barwick, D. C.; Schofield, W. C. E.; Garrod, R. P.; Ward, L. J.; Badyal, J. P. S. Langmuir 2005, 21, 11425.
(32) Schofield, W. C. E.; McGettrick, J.; Bradley, T. J.; Badyal, J. P. S.; Przyborski, S. J. Am. Chem. Soc. 2006, 128, 2280.
(33) Teare, D. O. H.; Schofield, W. C. E.; Garrod, R. P.; Badyal, J. P. S. J. Phys. Chem. B 2005, 109, 20923.
(34) Schofield, W. C. E.; Badyal, J. P. S. ACS Appl. Mater. Interfaces 2009, 1, 2763.
(35) Tarducci, C.; Schofield, W. C. E.; Brewer, S. A.; Willis, C.; Badyal, J. P. S. Chem. Mater. 2002, 14, 2541.
(36) Øye, G.; Roucoules, V.; Cameron, A. M.; Oates, L. J.; Cameron, N. R.; Steel, P. G.; Badyal, J. P. S.; Davis, B. G.; Coe, D.; Cox, R. Langmuir 2002, 18, 8996.
(37) Vasilev, K.; Britcher, L.; Casanal, A.; Griesser, H. J. J. Phys. Chem. B 2008, 112, 10915.
(38) Zelzer, M.; Alexander, M. R. J. Phys. Chem. B 2010, 114, 569.
(39) Ehrlich, C. D.; Basford J. A. J. Vac. Sci. Technol. A 1992, 10, 1.
(40) Lovering, D. NKD-6000 Technical Manual; Aquila Instruments: Cambridge, U.K., 1998.
(41) Lui-Viem, D. The Handbook of Infrared and Raman Characteristic Frequencies of Organic Molecules, Boston Academic Press, 1991.
(42) Horobin, R. W. Histochemical J. 1969, 3, 231.
(43) Isak, S. J.; Eyring, E. M. J. Photochem. Photobiol. A 1992, 64, 343.
(44) Barbetta, A.; Dentini, M.; Leandri, L.; Ferraris, G.; Coletta, A.; Bernabei, M. React. Funct. Polym. 2009, 69, 724.
(45) Hainey, P.; Huxham, I. M.; Rowatt, B.; Sherrington D. C.; Tetley, L. Macromolecules 1991, 24, 117.
(46) Barbetta, A.; Cameron, N. R. Macromolecules 2004, 37, 3188.
(47) Morsch, S.; Schofield, W. C. E.; Badyal, J. P. S. Langmuir 2010, 26, 12342.
(48) Cameron, N. R. Polymer 2005, 46, 1439.
(49) Shahidzadeh, N.; Bonn, D.; Aguerre-Chariol, O.; Meunier, J. Colloids Surf. A 1999, 147, 375.
(50) Greiner, R. W.; Evans, D. F. Langmuir 1990, 6, 1793.
(51) Frederikson, P.; Bjornholm, T.; Madsen, H. G.; Bechgaard, K. J. Mater. Chem. 1994, 4, 675.
(52) Uda, Y.; Kaneko, F.; Tanigaki, N; Kawaguchi, T. Adv. Mater. 2005, 17, 1846.
(53) Larpent, C.; Bernard, E.; Richard, J.; Vaslin, S. React. Funct. Polym. 1997, 33, 49.
(54) Larpent, C.; Bernard, E.; Richard, J.; Vaslin, S. Macromolecules 1997, 30, 354.
(55) Becker, J. R. Crude Oil Waxes, Emulsions and Asphaltenes, PennWell Books, 1997.
(56) Alexandratos, S. D.; Zhu, X. Macromolecules 2003, 36, 3436.
(57) Gurevitch, I.; Silverstein, M. S. J. Polymer Sci. A 2010, 48, 1516.
(58) Das, A. K.; Mukesh, D.; Swayambunathan, V.; Kotkar, D. D.; Ghosh, P. K. Langmuir 1992, 8, 2427.
(59) Ram, A. Fundamentals of Polymer Engineering Plenum Press New York, 1997.
(60) Baeurle, S. A.; Hotta, A.; Gusev A. A. Polymer 2006, 47, 6243.
(61) Carnachan, R. J.; Bokhari, M.; Przyborski S. A.; Cameron, N. R. Soft Matter, 2006, 2, 608.
(62) Bontempo, D.; Maynard, H. D. J. Am. Chem. Soc. 2005, 127, 6508.
(63) Xu, F. J.; Liu, L. Y.; Yang, W. T.; Kang, E. T.; Neoh, K. G. Biomacromolecules 2009, 10, 1665.
(64) Vogel, E.; Gbureck, A.; Kiefer, W. J. Mol. Struct. 2000, 550-551, 177.
(65) S. Zhang, J. Chen, V. T. Perchyonok, Polymer 2009, 50, 1723.
(66) J. Eastoe, B. H. Robinson, D. C. Steytler, J. Chem. Soc. Faraday Trans. 1990, 86, 511
(67) J. M. Williams, A. J. Gray, M. H. Wilkerson, Langmuir 1990, 6, 437.

1. A method for producing a porous polymer structure, the method involving:
(i) forming a polymer;
(ii) subsequently contacting the polymer with a nonsolvent and inducing the formation of an emulsion in which the nonsolvent is present as the dispersed phase and the polymer as the continuous phase; and
(iii) removing at least some of the nonsolvent so as to leave pores within the polymer, wherein the polymer is formed by exciting one or more molecules in an exciting medium.

2. A method according to claim 1, wherein the polymer is formed by plasma deposition, in particular a pulsed plasma deposition process.

3. A method according to claim 1, wherein the polymer is formed using a solventless deposition process.

4. A method according to claim 1, wherein emulsion formation in step (ii) is induced by or in the presence of an emulsion stabilising agent.

5. A method according to claim 4, wherein the emulsion stabilising agent is an amphiphilic species.

6. A method according to claim 4, wherein the polymer is impregnated with the emulsion stabilising agent before step (ii).

7. A method according to claim 4, wherein the polymer itself functions as an emulsion stabilising agent.

8. A method according to claim 1, wherein the nonsolvent is an aqueous liquid.

9. A method according to claim 1, wherein emulsion formation is induced at an elevated temperature.

10. A method according to claim 1, which also involves functionalising the polymer surface(s) during or after pore formation.

11. A method according to claim 10, wherein the polymer surface(s) are functionalised with a moiety which is capable of influencing the size of the pores depending on its physical state.

12. A method according to claim 11, wherein the functionalising moiety is hydrophilic, and is capable of reversibly swelling on exposure to an aqueous solvent.

13. A porous polymer structure produced using a method according to claim 1.

14. A product which is formed from or incorporates a porous polymer structure according to claim 13.

15. A polymer which is impregnated with an emulsion stabilising agent, for use in the emulsion formation step (ii) of a method according to claim 1.
